(19) United States
(12) Patent Application Publication
(10) Pub. No.: US 2011/0148607 A1
(43) Pub. Date: Jun. 23, 2011

(54) System,device and method for providing haptic technology

(76) Inventor: Charles Timberlake Zeleny, Baltimore, MD (US)

(21) Appl. No.: 12/654,324

(22) Filed: Dec. 17, 2009

(51) Int. Cl. H04B 3/36

(52) U.S. Cl. 340/407.1

(57) ABSTRACT

System and method of for providing haptic feedback to a subject. The method may include providing signals to an electronic interactive device, the device including an array of micro-step motors for contacting a skin surface of the subject and converting the signals to provide input signals to the array of micro-step motors. Haptic feedback may then be provided to the skin surface of the subject in response to the input signals. Exemplary micro-step motors may include two clutching actuators separated by a lateral actuator, each actuator adaptable to operate independently of the other actuators, and a shaft having a motion defined by movement of at least one of the lateral or clutching actuators.

### RELATED APPLICATIONS

The instant application is related to and copending with U.S. patent application Ser. No. ______ [T2203-00012], filed ______ and entitled, “System and Method for Determining Motion of a Subject,” the entirety of which is incorporated herein by reference. The instant application is related to and copending with U.S. patent application Ser. No. ______ [T2203-00014], filed ______ and entitled, “______,” the entirety of which is incorporated herein by reference. The instant application is related to and copending with U.S. patent application Ser. No. ______ [T2203-00016], filed ______ and entitled, “______,” the entirety of which is incorporated herein by reference. The instant application is related to and copending with U.S. patent application Ser. No. 12/292,948, filed Dec. 1, 2008 and entitled, “Zeleny Sonosphere,” the entirety of which is incorporated herein by reference. The instant application is related to and copending with U.S. patent application Ser. No. 12/292,949, filed Dec. 1, 2008 and entitled, “Zeleny Therapeutic Sonosphere,” the entirety of which is incorporated herein by reference.

### BACKGROUND

Embodiments of the present subject matter generally relate to devices, systems, devices and methods for providing haptic technology. Further embodiments of the present subject matter may provide methods, systems and devices for providing a virtual reality system.

Virtual reality systems and associated technologies have witnessed a steady evolution in a wide variety of industries, e.g., air traffic control, architectural design, aircraft design, acoustical evaluation, computer aided design, education (virtual science laboratories), entertainment, legal/police (re-enactment of accidents and crimes), medical applications such as virtual surgery, scientific visualization (aerodynamic simulations, computational fluid dynamics), telepresence, robotics, and flight simulators, to name a few.

Until recently, one component lacking in conventional virtual reality systems has been the sense of touch or “haptics.” In pre-haptic virtual reality systems, a user could reach out and touch a virtual object but would place his hand through the object thereby reducing the realistic effect of the associated system. Haptic technology, however, provides force feedback in which a user receives the sensation of physical mass in such objects presented in a virtual world by a computer.

Generally, haptic technology is an interfacing of a system with a user via the sense of touch through the application of forces, vibrations and/or motions to the user. This stimulation may be used to assist in the creation of virtual objects, to control and interact with virtual objects, persons and/or environments, and to enhance remote control of machines and devices. For example, haptic technology has made it possible to investigate how the human sense of touch works by allowing the creation of carefully controlled haptic virtual objects. Although devices employing haptic technology (“haptic devices”) may be capable of measuring and/or simulating bulk or reactive forces applied by a user, haptic technology should not be confused with touch or tactile sensors that measure the pressure or force exerted by a user to an interface.

When haptic technology is simulated (e.g., medical, flight simulators) using a computer, it may be useful to provide force feedback that would be felt in actual operations. Thus as objects being manipulated do not exist in a physical sense, the forces are generated using haptic (force generating) operator controls. Data representing such touch sensations may also be saved or played back using such haptic technologies. Some conventional haptic devices are provided in the form of game controllers, e.g., joysticks, steering wheels and the like. An example of this feature is an automobile steering wheel that is programmed to provide a “feel” of the road. As the user makes a turn or accelerates, the steering wheel responds by resisting turns or slipping out of control.

Haptic technology is gaining widespread acceptance as a key part of virtual reality systems, adding the sense of touch to previously visual-only solutions. Conventional haptic systems employ stylus-based haptic rendering, where a user interfaces to the virtual world via a tool or stylus, giving a form of interaction that may be computationally realistic. Systems are also being developed to use haptic interfaces for three dimensional modeling and design that are intended to give artists a virtual experience of real interactive modeling.

Haptic technology may also be employed in virtual arts, such as sound synthesis, graphic design and animation. For example, a haptic device may allow an artist to have direct contact with a virtual instrument which is able to produce real-time sound or images. These sounds and images may also be “touched” and felt. For instance, the simulation of a violin string may produce real-time vibrations of this string under the pressure and expressivity of a bow (haptic device) held by the artist. This may be accomplished employing some form of physical modeling synthesis. In this example, haptics may be enabled by actuators that apply forces to the skin for feedback and may provide mechanical motion in response to electrical stimuli. Most early designs of haptic feedback use electromagnetic technologies such as vibratory motors with an offset mass (e.g., a pager motor in a cell phone). These electromagnetic motors typically operate at resonance, provide strong feedback, but have limited range of sensations. There is a need, however, to offer a wider and more sensitive range of effects and sensations and provide a more rapid response time in a virtual reality environment.

Computer scientists, however, have had some difficulty transferring haptics into virtual reality systems. For example, visual and auditory cues are relatively simple to replicate in computer-generated models, but tactile cues are more problematic. Two types of feedback, kinesthetic and tactile, are available to haptics and may be referred to generally as force feedback. If a user is to feel or interact with a virtual object or person with any fidelity, force feedback should be received. Haptic systems generally require software to determine the forces that result when a user's virtual identity interacts with an object and a device through which those forces may be applied to the user. The actual process employed by the software to perform its calculations may be termed as haptic rendering. The conveyance of haptic simulations to a user falls to the applicable haptic interface device.

One known system employing haptic technology is the Phantom® interface from SensAble Technologies which provides a stylus connected to a lamp-like arm. Three small motors provide force feedback to a user by exerting pressure on the stylus thereby allowing the user to feel density, elasticity, temperature, texture, etc. of a virtual object. The stylus may be customized to resemble predetermined objects (e.g., medical devices). Another known system employing haptic technology is the CyberGrasp system from Immersion Corporation which provides a device adaptable to fit over a user's hand adding resistive force feedback to each finger. Five fingertip actuators produce the forces, which are transmitted along “tendons” connecting the fingertip actuators to the remaining portions of the device.

Additional virtual reality systems have been developed that incorporate haptic technology to some extent; however, these systems have several limitations such as, user occlusion of the graphics volume, visual acuity limitations, large mismatch in the size of graphics and haptics volumes, and unwieldy assemblies. For example, conventional rear-projection virtual reality systems create a virtual environment projecting stereoscopic images on screens located between the users and the projectors. These rear-projection systems, however, suffer from occlusion of the image by the user's hand or any interaction device located between the user's eyes and the screens, and if stereoscopic rear-projection systems are used, the visually stressful condition known as an accommodation-convergence conflict is created. Accommodation is the muscle tension needed to change the focal length of the eye lens in order to focus at a particular depth; convergence is the muscle tension needed to move both eyes to face the focal point. When looking at close objects, the convergence angle increases and the accommodation approaches its maximum, and the brain coordinates the convergence and the accommodation. However, when looking at stereo computer-generated images, the convergence angle between eyes still varies as the three-dimensional object moves back and forth, but the accommodation always remains the same because the distance from the eyes to the screen is fixed. When accommodation conflicts with convergence, the brain becomes confused and a user may experience headaches.

Conventional force feedback interface devices generally provide physical sensations to the user manipulating an object of the interface device through the use of computer-controlled actuators, such as motors, provided in an interface device. In most known force feedback interface devices, a host computer directly controls forces output by controlled actuators of the interface device, i.e., a host computer closes a control loop around the system to generate sensations and maintain stability through direct host control. This configuration has disadvantages as the functions of reading sensor data and outputting force values to actuators may be a burden on the host computer thereby detracting from its respective performance and execution. Additionally, low bandwidth interfaces are often used reducing the ability of the host computer to control realistic forces.

Typical multi-degree-of-freedom devices including force feedback also have several other disadvantages. For example, typical actuators supplying force feedback tend to be heavier and larger than sensors and would provide inertial constraints if added to a device. Further, if the device includes coupled actuators, where each actuator is coupled to a previous actuator in a chain, tactile “noise” may be imparted to the user through friction and compliance in signal transmission thereby limiting the degree of sensitivity conveyed to the user through the actuators. Portable mechanical interfaces having force feedback are, however, desirable in a virtual reality environment as active actuators, e.g., motors and the like, which generate realistic force feedback, but conventionally are bulky and cumbersome. Furthermore, active actuators typically require high speed control signals to operate effectively and provide stability. In many situations, such high speed control signals and high power drive signals are unavailable. Additionally, typical active actuators may sometimes prove unsafe for a user when strong, unexpected forces are generated.

In force feedback devices, it is thus important to have accurate control over the force output of the actuators on the device so that desired force sensations are accurately conveyed to the user. Typically, actuators are controlled as a function of the current through the actuator, such as a brushed DC motor or a voice coil actuator, that is, the torque output of the actuator is directly proportional to the actuator current. However, there are several different characteristics that make controlling current through the actuator difficult. These characteristics include the temperature variation of the coil in the actuator, back electromotive force from user motion of the manipulation of the device, power supply voltage variation, and coil impedance. Nonlinear force output response of such actuators in relation to command signal level or duty cycle may also cause problems in providing desired force magnitudes and sensations in force feedback applications as the force magnitude that is commanded to the actuator may not necessarily be the force magnitude that is actually output by the actuator to the user.

Accordingly, it is an object of embodiments of the present subject matter to overcome the limitations of virtual reality systems and haptics technology in the industry. Thus, there is an unmet need to provide a method, system and device for enhancing a virtual reality system.

### SUMMARY

One embodiment of the present subject matter may provide an electronic interactive device comprising a first surface and an array of micro-step motors. Each motor in the array may include two clutching actuators separated by a lateral actuator, each actuator adaptable to operate independently of the other actuators, and a shaft having a motion defined by movement of at least one of the lateral or clutching actuators, an end of the shaft being in contact with the first surface. The device may further comprise circuitry for receiving signals that provide an input to the array of motors configured to provide haptic feedback in response to the input.

A further embodiment of the present subject matter provides a method of providing haptic feedback to a subject. The method may include providing signals to an electronic interactive device, the device including an array of micro-step motors for contacting a skin surface of the subject and converting the signals to provide input signals to the array of micro-step motors. Haptic feedback may then be provided to the skin surface of the subject in response to the input signals.

One embodiment of the present subject matter provides an apparatus for delivering haptic stimuli to a skin surface of a user. The apparatus may include an array of micro-step motors for contacting the skin surface, and a printed circuit board connected to the array for independently providing electrical signals to each of the motors in a predetermined sequence. In one embodiment each of the motors may further comprise two clutching actuators separated by a lateral actuator, each actuator adaptable to operate independently of the other actuators and a shaft having a motion defined by movement of at least one of the lateral or clutching actuators, an end of said the being in contact with the skin surface.

These embodiments and many other objects and advantages thereof will be readily apparent to one skilled in the art to which the present subject matter pertains from a perusal of the claims, the appended drawings, and the following detailed description of the embodiments.

### BRIEF DESCRIPTION OF THE DRAWINGS

Various aspects of the present disclosure will become apparent to one with skill in the art by reference to the following detailed description when considered in connection with the accompanying exemplary non-limiting embodiments.

FIG. 1 is a block diagram of a system according to an embodiment of the present subject matter.

FIG. 2 is a diagram of an exemplary suit according to one embodiment of the present subject matter.

FIG. 3 is a diagram of an representative cross-section of a piece of material of the suit of FIG. 2.

FIG. 4 is a diagram of a micro-step motor according to an embodiment of the present subject matter.

FIG. 5 is a diagram of the interior of a piezo tube according to an embodiment of the present subject matter.

FIG. 6 is a diagram of the actuation process of a micro-step motor according to one embodiment of the present subject matter.

FIG. 7 is a perspective view of one embodiment of the present subject matter.

FIG. 8 is a diagram of another embodiment of the present subject matter

FIG. 9 is an illustration of another embodiment of the present subject matter.

FIG. 10 is a diagram of an exemplary processing system according to one embodiment of the present subject matter.

FIG. 11 is a depiction of one embodiment of the present subject matter.

### DETAILED DESCRIPTION

With reference to the figures where like elements have been given like numerical designations to facilitate an understanding of the present subject matter, the various embodiments of a system, device and method for providing haptic technology are herein described.

The following description is presented to enable a person of ordinary skill in the art to make and use various aspects of the present subject matter. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the subject matter. Thus, the present subject matter is not intended to be limited to the examples described herein and shown, but are to be accorded the scope consistent with the claims.

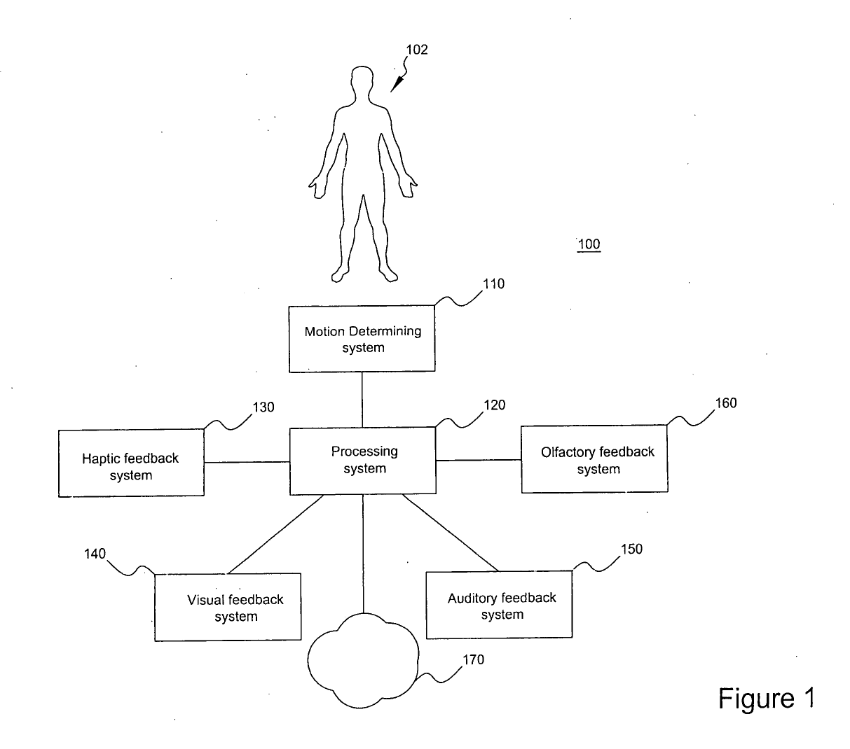

FIG. 1 is a block diagram of a system according to an embodiment of the present subject matter. With reference to FIG. 1, a virtual reality system 100 may comprise a motion tracking or determining system 110 and a processing system 120. Exemplary motion determining systems 110 and processing systems 120 are described in related and copending U.S. patent application Ser. No. ______ [T2203-00012], filed ______ and entitled “System and Method for Determining Motion of a Subject,” the entirety of which is incorporated herein by reference. The system 100 may also include a haptic feedback system 130, a visual feedback system 140, an auditory feedback system 150, and/or an olfactory feedback system 160 to provide touch, visual, olfactory and auditory feedback to enhance a user's virtual reality experience. An exemplary system 100 may thus simulate any type of operation involving human behavior, human movement or interactions with an environment, object, other person or avatar in a wide variety of industries and occupations, e.g., computer or video gaming, surgery, adult entertainment, soldier, surgeon, aircraft pilot, astronaut, scientist, construction worker, etc. Exemplary systems 100 according to embodiments of the present subject matter may also be utilized for training purposes, and provide for real-time interactivity, especially when connected to cybernetically-interfaced tactilo-haptic machines, capable of working in non-human environments (e.g., nuclear core reactors, miniature surgical environments, and deep sea work and the like).

As described in copending U.S. patent application Ser. No. ______ [T2203-00012], an exemplary motion tracking or determining system 110 may include devices for tracking the kinematics or position of certain points (e.g., SAT Points or transponders) in three-dimensional space over time. These devices may also track the position or angle of these points on X, Y, and Z axes with respect to each other or employ other motion tracking techniques. The motion determining system 110 may be capable of making several or in excess of millions of measurements of position every second to simulate continual movement and provide this data to an exemplary tetrabytic-paced processing system 120.

In one embodiment of the present subject matter, the haptic feedback system 130 may include a wearable element such as a glove, suit, goggles, or other garment or may be a touchpad, screen or other physical element that a user 102 thereof can hold, touch or interact with in reality. Of course, other physical elements are envisioned and such examples should in no way limit the scope of the claims appended herewith. In another embodiment, the system 100 may not include such a corresponding physical element whereby the virtual element would exist only in the virtual environment and be completely virtual.

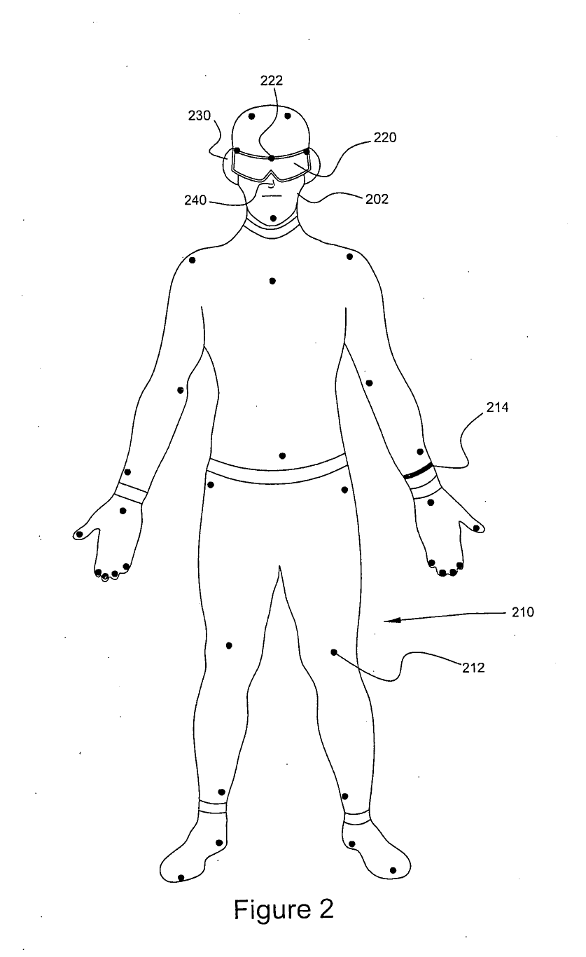

For example, the haptic feedback system 130 may include a wearable garment such as a full body suit. FIG. 2 is a diagram of an exemplary suit according to one embodiment of the present subject matter. With reference to FIG. 2, an exemplary suit 210 may include a plurality of sensors such as, for example, SAT Points or transponders 212 described in co-pending U.S. patent application Ser. No. ______ [T2203-00012] for determining the motion of a user 202 of the suit 210. The user 202 may also be wearing goggles 220 having one or more transponders 222 and may be wearing earpieces or plugs 230 having one or more transponders. Exemplary goggles 220 according to an embodiment of the present subject matter are described in co-pending U.S. application Ser. No. ______ [12203-000XX] and exemplary earpieces according to an embodiment of the present subject matter are described in co-pending U.S. application Ser. No. ______ [T2203-000XX]; however, such disclosures should not limit the scope of the claims appended herewith. The user(s) may be wearing a clip microphone, or a microphone built into the above referenced full or partial body suit or garment. Alternatively, a miniaturized wireless microphone may be subcutaneously located in the flesh just below the septal cartilage of the nose. The goggles 220 may provide input and receive output from the visual feedback system 140 with the attendant transponders 222 providing input and receiving output, as appropriate, from the motion determining system 110. The earpieces or plugs 230 may provide input and receive output from the auditory feedback system 150 with any attendant transponders providing input and receiving output, as appropriate, from the motion determining system 110. The user 202 may additionally be wearing a wired or wireless nosepiece 240 equipped with an olfactic delivery system (ODS,) having one or more transponders, the nosepiece 240 providing input and receiving output from the olfactory feedback system 160 with any attendant transponders providing input and receiving output, as appropriate, from the motion determining system 110. An exemplary suit 210 or other garment may also include one or more cuffs 214 of material strategically placed at the wrist of the user 202 or other vital locations to monitor physiological conditions of the user 202. In another embodiment, the suit may be outfitted with electrodes (not shown) that monitor physiological conditions of the user 202 or the wearable transponders or subcutaneous transponders may monitor physiological conditions of the user 202. Of course, the transponders or SAT Points may be of the adhesive- or patch-type disclosed in co-pending U.S. patent application Ser. No. ______ [T2203-00012], and the embodiment described above should not limit the scope of the claims appended herewith. Further, communication and power to/from such exemplary haptic devices may be wireless or wired, as appropriate.

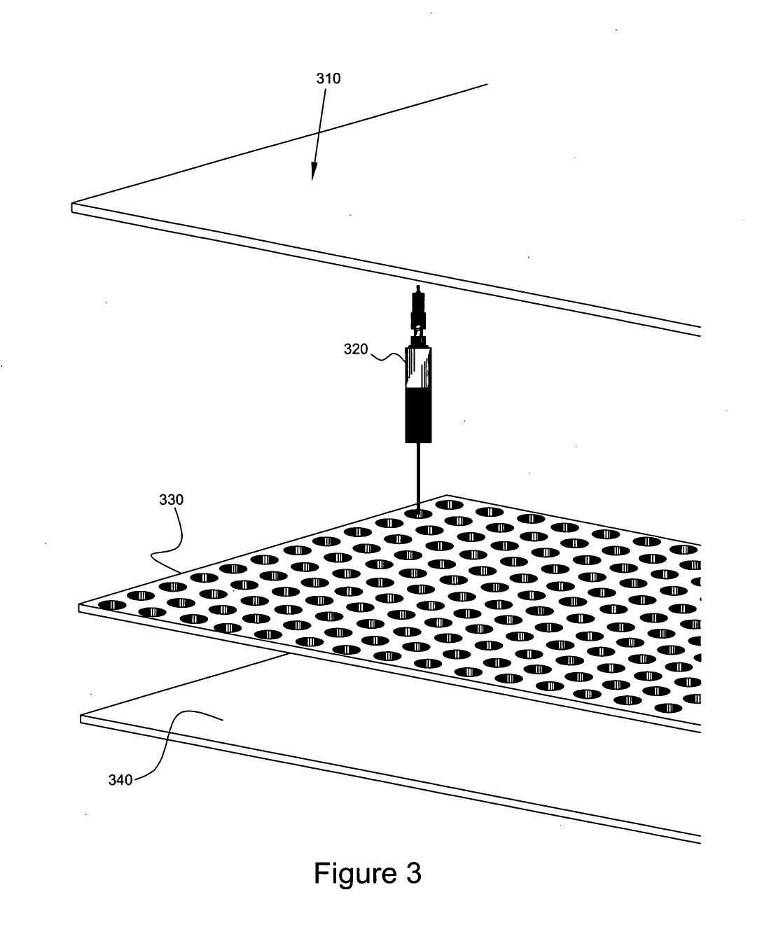

The suit 210 or any other exemplary haptic garment or wearable device may, on the surfaces thereof in contact with the user's skin, provide an array of exemplary mechanical, electrical, electro-mechanical, piezoelectric, electrostrictive or hydro-digitally gauged actuators. FIG. 3 is a diagram of an representative cross-section of a piece of material of the suit 210. With reference to FIG. 3, a surface 310 of the suit proximate a user's skin may provide a plurality of hydraulic, digitally-gauged, micro-step motors 320 that are computer coordinated to simulate a haptic action and/or reaction. The surface 310 may comprise exemplary materials such as, but not limited to, latex, cloth, neoprene, silicone, polyester, flexible polyvinylchloride, nitrile, ethylene vinyl acetate, ethylene propylene diene monomer rubber, viton, polyether, foam, rubber, fluorosilicone, polycarbonate, cork, nomex, kapton, plastic, elastomers, reverse exterior touchpad material, and combinations thereof. For example, within one square foot of cloth of the suit, there may be between one thousand to fifty thousand micro-step motors 320 that are substantially fixed to a flexible, optically printed routing board, flexible printed circuit board or other surface 340 via a perforated, flexible bracing piece 330.

One exemplary micro-step motor 320 may comprise a micropositioning or nanopositioning rotary motor or linear motor. Typical micropositioning rotary motors may be based on electromagnetic attraction and repulsion, e.g., direct current (“DC”) servomotors and stepper motors. DC servomotors may be permanent magnet field/wound rotor motors adaptable to provide linear torque/speed characteristics and controllable as a function of the applied voltage. Speed control may be employed through use of DC power amplifiers and feedback control may be realized using speed sensors. Shaft-mounted rotary encoders may also be employed to produce signals indicative of incremental motion and direction and the respective control system may convert this rotary motion information into linear motion results using conversion factors based on the system's mechanical transmission. A stepper motor, on the other hand, may be digital in operation and the change of direction of current flow through the respective windings may generate rotation in fixed increments. Control of the acceleration of a stepper motor and of the load may be required to ensure that the motor will respond to the switching frequency, and rotary incremental encoders may be utilized to monitor the actual motion.

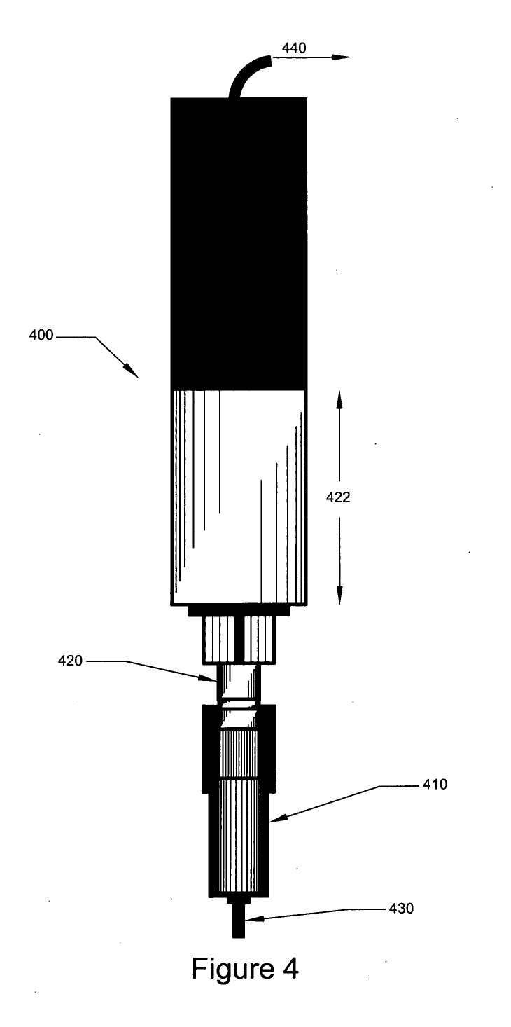

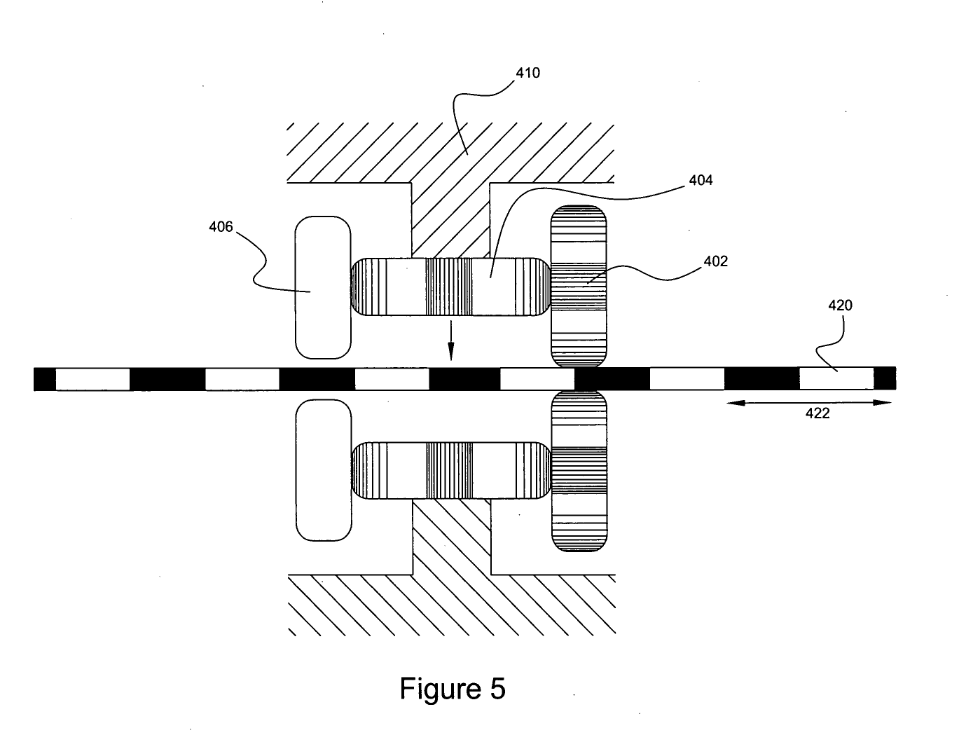

One preferable micro-step motor may be an inchworm motor adaptable to achieve motion via the action of piezoelectric elements that change dimensions under the influence of electric fields. One exemplary inchworm motor is manufactured by EXFO Burleigh Products Group and is generally a device employing piezoelectric actuators to move a shaft with nanometer precision. FIG. 4 is a diagram of a micro-step motor according to an embodiment of the present subject matter. FIG. 5 is a diagram of the interior of a piezo tube according to an embodiment of the present subject matter. With reference to FIGS. 4 and 5, an exemplary micro-step motor 400 according to one embodiment may comprise three piezo-actuators, a lateral actuator 404 and two clutching actuators 402, 406, connected together within a piezo tube 410, each actuator adaptable to independently grip a shaft 420. Though all three actuators may operate independently, the three elements are physically connected. Generally, the actuators 402, 404, 406 are electrified in sequence to grip the shaft 420 move the shaft 420 in a linear direction 422. Motion of the shaft is generally a function of the extension of the lateral actuator 404 pushing on the two clutching actuators 420, 406.

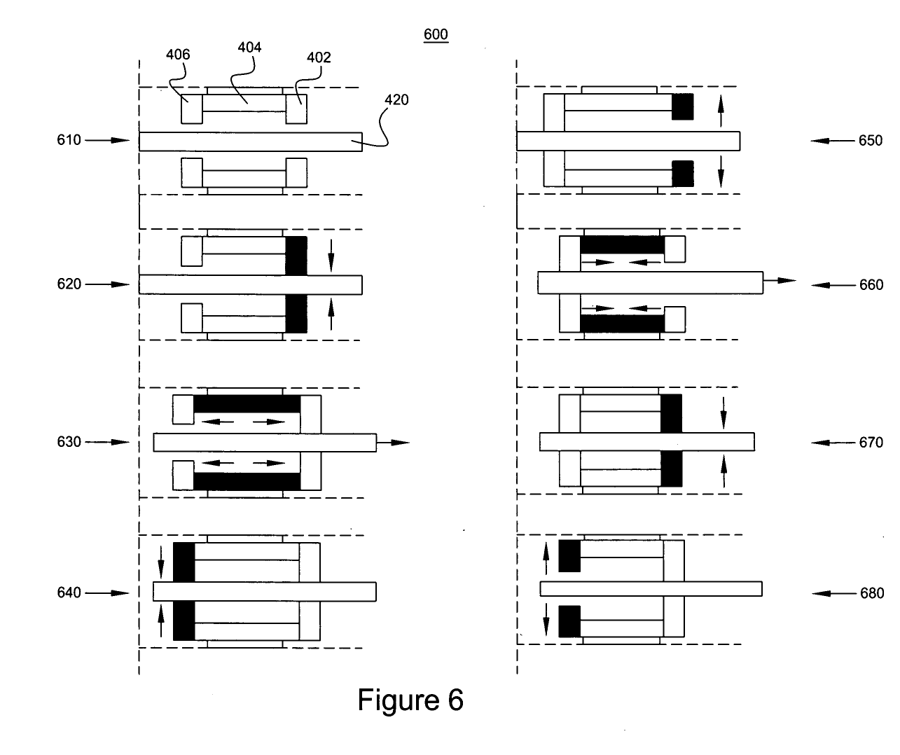

FIG. 6 is a diagram of the actuation process of a micro-step motor according to one embodiment of the present subject matter. With reference to FIG. 6, an exemplary actuation process 600 of the micro-step motor illustrated in FIGS. 3-5 may be a six step cyclical process after an initial relaxation phase 610 and initialization phase 620. Initially, all three actuators 402, 404, 406 are relaxed and unextended in the relaxation phase 610. To initialize an exemplary micro-step motor in the initialization phase 620, a first clutching actuator 402 (closest to the direction of desired motion) may be electrified first, then a six step cycle begins. In the first step 630, a voltage may be applied to the actuator 402 closest to the direction of desired motion to clamp the shaft 420, and then an increasing staircase voltage may be applied to the lateral actuator 404, causing the lateral actuator 404 to change length in discrete steps of a predetermined distance, thus causing the shaft 420 to move forward. The size of the shaft movement is generally a function of voltage and motor loading; thus, certain embodiments may employ an encoder to gain information regarding speed and location to control such movement. Further, the staircase voltage may be stopped or reversed on any step. At the top of the staircase voltage applied to the lateral actuator 404, a voltage may be applied to the second clutching actuator 406 at step 640, causing the second clutching actuator 406 to clamp the shaft 420. At step 650, voltage may be removed from the first clutching actuator 402, causing the first clutching actuator 402 to release the shaft 420. The staircase voltage applied to the lateral actuator 404 begins to step downward causing the lateral actuator 404 to change length, again moving the shaft 420 forward at step 660, until the staircase voltage reaches a predetermined level. When the staircase voltage applied to the lateral actuator 404 is at this level, the first clutching actuator 402 closest to the direction of desired motion is again activated at step 670, and at step 680, the second clutching actuator 406 releases the shaft 420 whereby the staircase voltage begins to increase. This sequence 600 may be repeated any number of times for a travel limited only by the length of the shaft 420. Furthermore, the direction of travel may also be reversed to move the shaft 420 in the opposite direction as appropriate. If the expansion of the lateral actuator 404 is precisely calibrated and slip for the other two actuators 402, 406 is negligible, then the position of the shaft 420 may be precisely controlled while providing a substantial travel distance limited by the shaft length. Thus, an end 430 of the micro-step motor shaft 420 may respond to touch by a user and/or reciprocate touch over traditional telecommunication technologies (e.g., wireless, wired, Internet, cellular, etc.) via a controller or connection 440.

Certain embodiments may employ optical encoders to measure the actual motion of the shaft 420 or applicable load. Exemplary micro-step motors may thus eliminate backlash, provide almost instantaneous acceleration and provide high mechanical resolution and dynamic range of speed. For example, since dimensional changes are generally proportional to the applied voltage, the movement of the respective shaft may be adjusted with extremely high resolution. Additionally, due to the piezoelectric properties of the micro-step motor described above, a pure capacitive load is presented to any driving electronics which, when stopped, dissipate almost no energy and thus no heat. Thus, virtually no power is consumed or heat generated when maintaining these actuators in an energized (holding) state. Further, conversion of electrical energy into mechanical motion may take place without generating any significant magnetic field or the need for moving electrical contacts in certain embodiments of the present subject matter. Actuators in an exemplary micro-step motor according to embodiments of the present subject matter may also be operated over millions of cycles without wear or deterioration, and their high response speed is limited only by the inertia of the object being moved and the output capability of the electronic driver.

It is therefore an object of an embodiment of the present subject matter to provide a garment or other device or apparatus that, in connection with the use of SAT Points or transponders, virtual reality goggles and/or other devices, may allow a user a complete virtual reality simulation. An exemplary embodiment may thus lend itself to a virtual reality environment and act as a sensory avatar in gaming, psychotherapeutic, and other applications. For example, exercise applications utilizing embodiments of the present subject matter may increase interest in fitness through a virtual reality environment, and with the monitoring of a user's physiological information, experiences therapeutic or otherwise may be heightened. Further, when embodiments of the present subject matter are utilized in the healing arts, in virtual reality gaming, or in sexual encounters, the embodiments may enable a haptic “cause and effect” through high speed Internet. Thus, couples or multiple users, both real and/or virtual, may interact and friends, partners and loved ones may literally reach out and touch or physically interact with one another over long distances. Embodiments of the present subject matter may also be employed in remote reiki, massage and other healing arts. Embodiments of the present subject matter may thus set forth a new standard for disease-free sexual encounters, person-to-person interactions, and recreational use in this manner may become very popular. It is also envisioned that additional attachments or devices utilizing or used in conjunction with embodiments of the present subject matter may make possible more accurate virtual reality sexual encounters, be the encounters human to human or human to computer program. While conventional virtual reality systems generally allow customization of a user's avatar, embodiments of the present subject matter allow such customization but also allow a user's avatar to move exactly as the user would thus enabling virtual reality sexual experiences as well as any other human experiences, to be visualized and felt as if in person.

Embodiments of the present subject matter may thus enable real-time epidermal sensory of the gathering of avatars shaking hands, patting each other on the back, and other physical interactions in gaming or other applications. Embodiments of the present subject matter may also be employed conjunction with the inventions described in co-pending U.S. patent application Ser. Nos. ______ [T2203-00012], ______ [T2203-00014], ______ [T2203-00016], 12/292,948, and 12/292,949 the entirety of each incorporated herein by reference, whereby the embodiment may take on a, particularly, vehicular manifestation and simulation of wind may be possible. Additional applications for embodiments of the present subject matter may also extend to interactive billboards, terrain simulators, fluid dynamic and mechanic models, gaming, cybersex, attachments allowing for avionics, remote surgery, reiki, massage and healing arts, to name a few. Additionally, while several embodiments have been described with respect to specific garments, other embodiments of the present subject matter may find utility in touchpads, touchscreens, displays, keyboards, buttons, gloves, shirts, hats, goggles, physical tools, spectacles, shoes, pants, socks, undergarments, clothing accessories, necklaces, bracelets, jewelry, and combinations thereof.

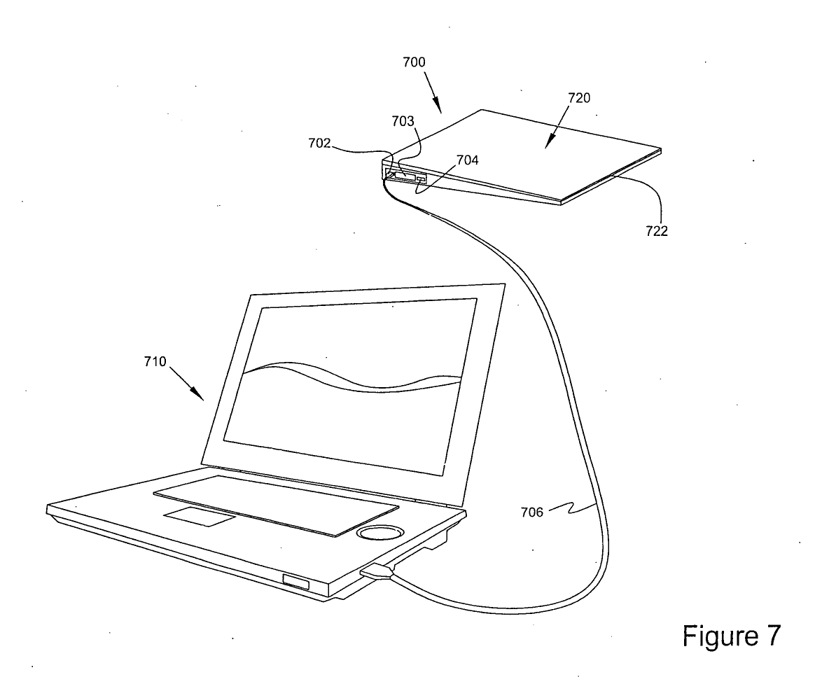

For example, in another embodiment, the haptic feedback system 130 may comprise a touchpad or similar device. FIG. 7 is a perspective view of one embodiment of the present subject matter. With reference to FIG. 7, an exemplary haptic touchpad 700 may be provided to a user, the touchpad 700 adaptable to be connected to a computer 710 via one or more ports 702, 703, 704 (e.g., universal serial bus (“USB”) port and the like) and any appropriate cabling 706 such as, but not limited to, a USB cable, firewire, standard serial bus cable, and other ports or cabling (wire or wireless), etc. Of course, the haptic touchpad 700 may communicate with the computer 710 wirelessly and the previous examples should not limit the scope of the claims appended herewith. The computer 710 may be a portable or laptop computer or may be a desktop computer. Alternative embodiments of the computer 710 may also take the form of a stand-up arcade machine, other portable devices or devices worn on a user's person, handheld devices, a video game console, a television set-top box, or other computing or electronic device. The computer 710 may operate one or more programs with which a user is interacting via peripheral equipment. The computer 710 may include any number of various input and output devices, including, but not limited to, a display for outputting graphical images to a user thereof, a keyboard for providing character input, and a touchpad 700 according to an embodiment of the present subject matter. The display may be any of a variety of types of displays including without limitation flat-panel displays or a display described in co-pending U.S. patent application Ser. No. ______ [T2203-000XX], the entirety of which is incorporated herein by reference. Of course, other devices may also be incorporated and/or coupled to the computer 710, such as storage devices (hard disk drive, DVD-ROM drive, etc.), network server or clients, game controllers, etc.

One touchpad 700 according to an embodiment of the present subject matter may include an array of or one or more exemplary mechanical, electrical, electro-mechanical, piezoelectric, electrostrictive actuators depicted in FIGS. 3-4. For example, a surface 720 of the touchpad 700 proximate a user may provide a plurality of hydraulic, digitally-gauged, micro-step motors that are computer coordinated to simulate a haptic action and/or reaction. Thus, within the confines of the touchpad 700 there may be over fifty thousand micro-step motors substantially fixed to a routing board or other surface adaptable to accept signals from the micro-step motors and provide such signals to appropriate circuitry. Of course, depending upon the dimensions of the touchpad 700, there may be less or more than fifty thousand micro-step motors and such a number is exemplary only and should not limit the scope of the claims appended herewith.

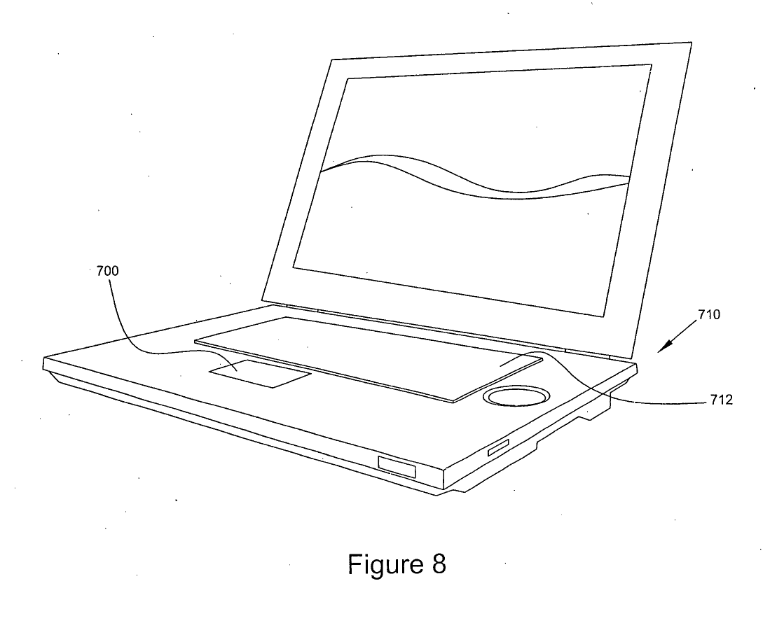

The planar (square, rectangular or otherwise) surface 720 of the touchpad 700 may be substantially smooth if a flexible layer of material 722 overlies the array of micro-step motors or, in another embodiment, a user may directly contact the array of micro-step motors without any intervening layer. While the instant embodiment has been illustrated as a peripheral device to the computer 710, it is envisioned that an exemplary touchpad 700 may be incorporated in a laptop computer 710, desktop computer, video game console, a television set-top box, or other computing or electronic device as shown in FIG. 8. Additionally, the entirety of the keyboard 712 may be employed as a touchpad thereby removing the need for conventional keyboard circuitry, buttons and other components.

In one embodiment of the present subject matter, the touchpad 700 may be employed to manipulate images and/or icons on traditional screen displays on the computer 710 or may, in the case of a user wearing virtual reality goggles 220, be employed to manipulate images and/or icons displayed in the virtual reality goggles 220 of a user. Exemplary touchpads 700 may also be employed in conjunction with a garment such as a glove, suit, fingertip attachments, or the like that utilizes SAT Points or transponders utilized to track a user's fingers, hands, etc. In such an embodiment, a soldier or grandmother may feel the touch of the hands and fingers, from a remote location thousands of miles away, of his or her son, daughter, grandchild, etc. Furthermore, pictures and/or touch scribed by children and adults may be reciprocated and transmitted in real-time across the Internet and/or stored for later use, or as shared playback material. In another embodiment, world leaders, politicians and the like may employ embodiments of the present subject matter to touch the hands of thousands of people or constituents in live or prerecorded sessions, without the security concerns prevalent in face-to-face encounters. In another embodiment, entertainment experienced via films, television, live performance and the internet may be recorded by virtual filmmakers using actors and/or digital facsimiles of known actors thus providing a prerecorded or live and/or interactive “walk-around” and tactile film or program. Additional applications for touchpads 700 according to embodiments of the present subject matter may also find relevance to the blind. For example, using embodiments of the present subject matter braille may be provided to a detailed degree and typing may be more accessible for the blind as the touchpad 700 may be transformed, through use of appropriate software, into a regular or braille keyed typing instrument.

The touchpad 700 may also provide certain functionality similar to conventional touchpads. For example, one functionality may be where the speed of a user's fingertip, hand, etc. on the touchpad 700 correlates to the distance that a corresponding cursor is moved in a graphical environment on a display. For example, if a user moves his finger, hand, etc. quickly across the touchpad 700, the cursor may be moved a greater distance than if the user moves the same more slowly. Another function may be an indexing function where, if a user's finger, hand, etc. reaches the edge of the touchpad 700 before the cursor reaches a desired destination in that direction, then the user may simply move the same off the touchpad 700, reposition the same away from the edge, and continue moving the cursor. Furthermore, another touchpad 700 according to an embodiment of the present subject matter may also be provided with particular regions (not shown) assigned to particular functions unrelated to cursor positioning. Additional functionalities for the touchpad 700 may include allowing a user to tap or double-tap the touchpad 700 in a particular location thereof to provide a command, select an icon, etc. Of course, one or more buttons may also be provided on the touchpad 700 to be used in conjunction with the operation thereof. A user's hands may thus be provided with easy access to the buttons, each of which may be pressed by the user to provide a distinct input signal to the computer 710. These buttons may be similar to buttons found on a conventional mouse input device such that the left button can be used to select a graphical object and the right button can be used for menu selection. Of course, these buttons may also provide haptic input/output and may be used for other purposes.

A host application program(s) and/or operating system may display graphical images of an exemplary virtual reality environment on a display of the computer 710 or in goggles worn by the user. The software running on the host computer 710 may be of a wide variety, e.g., a word processor, spreadsheet, video or computer game, drawing program, operating system, graphical user interface, simulation, Web page or browser, scientific analysis program, virtual reality training programs or applications, or other application programs that utilize input from the touchpad 700 and provide force feedback commands to the touchpad 700.

The touchpad 700 may also include circuitry necessary to report control signals to the microprocessor of the computer 710 and to process command signals from the host computer's microprocessor. The touchpad 700 may also include circuitry that receives signals from the computer 710 and outputs tactile or haptic sensations in accordance with signals therefrom using one or more actuators in the touchpad 700. In one embodiment, a separate, local microprocessor may be provided for the touchpad 700 to report touchpad sensor data to the computer 710 and/or to carry out force feedback commands received from the computer 710. Of course, the touchpad microprocessor may simply pass streamed data from the computer 710 to actuators in the touchpad 700. The touchpad microprocessor may thus implement haptic sensations independently after receiving a host command by controlling the touchpad actuators or, the microprocessor in the computer 710 may be utilized to maintain a greater degree of control over the haptic sensations by controlling the actuators in the touchpad 700 more directly. While only the touchpad 700 was described as having additional local circuitry for predetermined purposes, it should noted that any haptic device according to embodiments of the present subject matter, whether the device be a suit, glove, other garment, etc., may include also such circuitry and the scope of the claims appended herewith should be given their full range of equivalence.

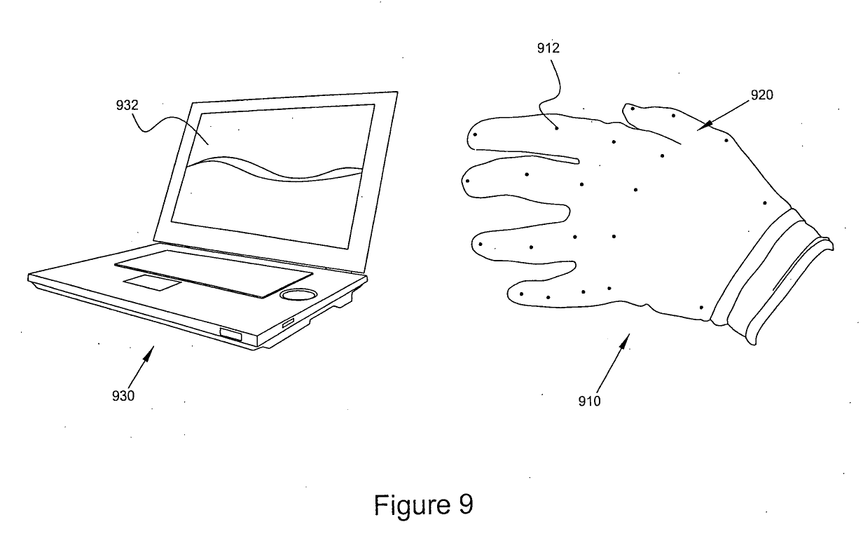

FIG. 9 is an illustration of another embodiment of the present subject matter. With reference to FIG. 9, a user may be equipped with a glove 910, one or more finger attachments or other suitable garment that includes an array of or one or more exemplary mechanical, electrical, electro-mechanical, piezoelectric, electrostrictive actuators depicted in FIGS. 3-5. For example, a surface of the glove or other garment proximate a user's skin may provide a plurality of hydraulic, digitally-gauged, micro-step motors that are computer coordinated to simulate a haptic action and/or reaction. As discussed above, there may be between one thousand to fifty thousand micro-step and/or hydro-digitally gauged micro-step motors substantially fixed to an optically printed routing board or other surface via a perforated, bracing piece. The outer surface 920 of the glove 910 or other garment distal the user's skin may be any typical cloth, latex cover, etc. The glove 910 may contain any number of SAT Points or transponders 912 utilized to track the movement of the glove 910 in three-dimensional space. Exemplary embodiments may thus be employed to “reach inside” an application operating on a proximate or remote computer 930 to feel and/or move objects, icons, and the like according to the visual information being displayed on the computer's display 932 or displayed in a user's virtual reality goggles (not shown), such as, but not limited to goggles described in co-pending U.S. patent application Ser. No. ______ [T2203-00014], the entirety of which is incorporated herein by reference. Of course, the glove 910 or other garment may be a peripheral attachment wired to the computer 930 and the exemplary embodiment above should not limit the scope of the claims appended herewith. As described above with the touchpad 700, this particular embodiment 910 may also be of extraordinary utility to the blind in their respective ability to utilize a computer at the same level of articulation enjoyed by those users having sight.

With continued reference to FIG. 1, an exemplary processing system 120 may include any suitable processing and storage components for managing motion information measured, received and or to be transmitted by the motion determining system 110 and other systems 130-160. For example, as a user wearing or utilizing an exemplary apparatus moves or manipulates the apparatus, the processing system 120 may determine the result of an interaction between the apparatus and a virtual subject/object 170 or avatar(s) using real time detection of their respective X, Y and Z axes. Based upon determinations of the interaction between the apparatus and the virtual subject/object 170, the processing system 120 may determine haptic feedback signals to be applied to the haptic feedback system 130. Likewise, the processing system 120 may determine visual signals that are applied to the visual feedback system 140 to display to the user 102 a virtual image of the interactions with the virtual subject/object 170. The processing system 120 may also determine auditory signals that are applied to the auditory feedback system 150 to provide to the user 102 audible sounds of interactions with the virtual subject/object 170 via location microphones, suit microphones and/or the aforementioned, miniaturized wireless microphone, subcutaneously located in the flesh just below the septal cartilage of the nose. Additionally, the processing system 120 may determine olfactory signals that are applied to the olfactory feedback system 160 to provide to the user 102 distinguishable scents or smells of applicable interactions with the virtual subject/object/environment 170.

The haptic feedback system 130 may include any suitable device that provides any type of forced feedback, vibrotactile feedback, and/or tactile feedback to the user 102. This feedback is able to provide the user with simulations of physical texture, pressures, forces, resistance, vibration, etc. of virtual interactions which may be related in some respects to responses to an applicable apparatus's movement in three dimensional space and/or including any interaction of the apparatus, and hence user, with the virtual subject/object/environment 170.

The visual feedback system 140 may include any suitable virtual reality display device, such as virtual goggles, display screens, etc. Exemplary virtual goggles are described in co-pending U.S. patent application Ser. No. ______ [T2203-00014], the entirety of which is incorporated herein by reference. The visual feedback system 140 may provide an appearance of the virtual subject/object/environment 170 and how the subject/object/environment 170 reacts in response to interactivity by the user 102. The visual feedback system 140 may also show how the subject/object/environment 170 reacts to various environmental virtual forces or actions applied thereto by applications and/or programs resident on the processing system 120 or on a remote processing system.

Generally, the motion determining system 110 may track motion of one or more portions, the entirety of a user's body or of an object, e.g., vehicle, tool, table, rock, chair, and the distinctive calculation of distances involved with simulation such as mountains, clouds, stars, etc. Motion data may be sent from the motion determining system 110 or other system to and received by the processing system 120, which processes the data and determines how the data affects the virtual subject/object 170 and or virtual environment. In response to these processing procedures, the processing system 120 may provide haptic, visual, olfactory, auditory and gustative feedback signals to the respective feedback systems 130, 140, 150, 160 based upon interactions between the user 102 and the virtual subject/object 170 and/or virtual environment as a function of the particular motion of the user 102, particular motion or characteristics of the subject/object 170, and characteristics, motion, etc. of a respective virtual environment and the experiences described in co-pending U.S. patent application Ser. No. ______ [T2203-00016], the entirety of which is incorporated herein by reference.

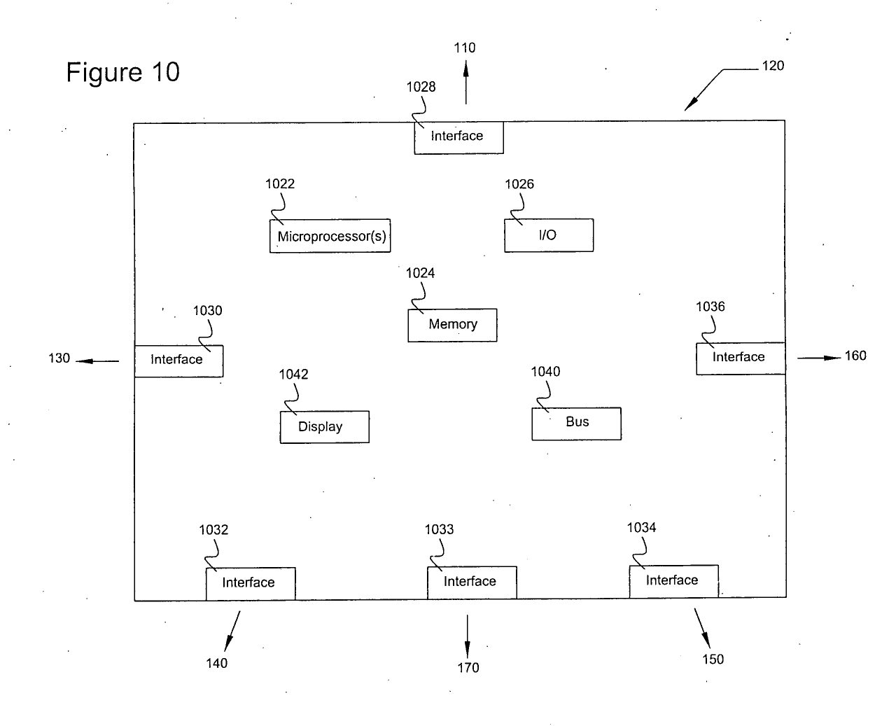

FIG. 10 is a diagram of an exemplary processing system according to one embodiment of the present subject matter. With reference to FIG. 10, an exemplary processing system 120 may analyze information measured and/or transmitted from haptic devices according to embodiments of the present subject matter and may analyze information received and/or transmitted from remote locations and users. The processing system 120 may include a microprocessor(s) 1022, memory 1024, input/output devices 1026, motion determining system interface 1028, haptic device interface 1030, visual device or display interface 1032, interface 1033 with remote processing systems or devices, auditory device interface 1034, vocal and gustative interfaces, and an olfactory device interface 1036, each interconnected by an internal bus 1040 or other suitable communication mechanism for communicating information. The processing system 120 may also include other components and/or circuitry associated with processing, receiving, transmitting and computing digital or analog electrical signals. The microprocessor 1022 may be a general-purpose or specific-purpose processor or microcontroller, and the memory 1024 may include internally fixed storage and/or removable storage media for storing information, data, and/or instructions. Storage within the memory components may include any combination of volatile memory, such as random access memory (“RAM”), and/or non-volatile memory, such as read only memory (“ROM”). The memory 1024 may also store software program(s) enabling the microprocessor 1022 to execute a virtual reality program or procedure. Various logical instructions or commands may be included in the software program(s) for analyzing a user's movements and regulating feedback to the user 102 based on virtual interactions among apparatuses and devices worn by the user, devices employed by the user, a virtual environment, and/or a virtual subject/object 170. Exemplary virtual programs may be implemented in hardware, software, firmware, or a combination thereof and when implemented in software or firmware, the virtual program may be stored in the memory 1024 and executed by the microprocessor 1022. The virtual program may also be implemented in hardware using, for example, discrete logic circuitry, e.g., a programmable gate array (“PGA”), a field programmable gate array (“FPGA”), etc. Of course, the memory 1024 and other components associated with the processing system 120 may be configured in other processing systems, incorporated on removable storage devices, and/or accessible via a modem or other network communication device(s) of varying bandwidths.

The memory 1024 may include files having information for simulating various portions of a virtual environment, may include software programs or code for defining or setting rules regarding interactions between a user and the virtual environment or remote and virtual subjects/objects 170. Input/output devices 1026 for the processing system 120 may include keyboards, keypads, cursor control devices, other data entry devices, computer monitors, display devices, printers, and/or other peripheral devices. The input/output devices 1026 may also include a device for communicating with a network, such as a modem, for allowing access to the network, such as the Internet and may communicate with the internal bus 1040 via wired or wireless transmission.

The motion determining system interface 1028 may receive information received by the motion determining system 110 or may transmit or provide information to the motion determining system 110. This information may be stored in the memory 1024 and processed to determine the position and/or orientation of a user 102 in relation to virtual subjects/objects and/or a virtual environment. Based on movements and interactions of the user 102 and any applicable devices or apparatuses with virtual objects/subjects and/or a virtual environment, the microprocessor 1022 may determine force feedback signals to be applied to the user 102 whereby the haptic device interface 1030 transfers haptic feedback signals to the haptic feedback system 130 to simulate tactile sensations, the visual device or display interface 1032 transfers visual signals to the visual feedback system 140 to simulate visual images of a virtual environment and/or virtual subjects/objects, the auditory device interface 1034 transfers auditory signals to the auditory feedback system 150 to simulate audible noises in the virtual environment and/or from virtual subjects/objects or interactions therewith, and the olfactory device interface 1036 transfers olfactory signals to the olfactory feedback system 160 to simulate perceptible scents or smells in a virtual environment, from virtual subjects/objects and/or from vocal or gustative information.

The processing system 120 may also include tracking software that interacts with the motion determining system 110 to track a user's portions tagged with SAT points or transponders to computer correct perspectives while a user moves his body around a virtual environment. The processing system 120 may further include haptics rendering software to monitor and control the haptic devices and may also include visual, olfactory, and auditory software to monitor and control any respective sensory devices employed by a user. For example, the haptics rendering software may receive information regarding the position and orientation of an exemplary haptic device and determine collision detections between the haptic device and virtual objects/subjects and/or the virtual environment. The haptics rendering software may thus receive three dimensional models from the memory, remote sites, etc. and provide information to direct the haptic device to generate the corresponding force feedback. Of course, applicable sound rendering software may be employed in preferred embodiments to add auditory simulations to the virtual environment, visual rendering software employed to add visual simulations to the virtual environment, and olfactory rendering software employed to add detectable simulations of smell to the virtual environment.

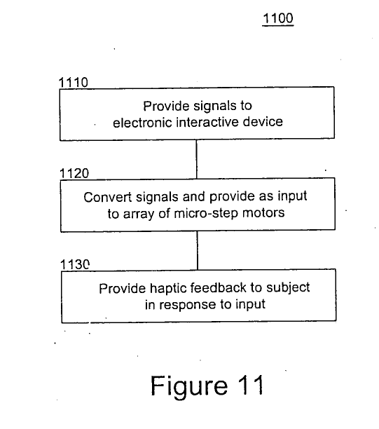

The processing system 120 may be any of a variety of computing or electronic devices such as, but not limited to, a personal computer, game console, or workstation, a set-top box (which may be utilized to provide interactive television functions to users), a networked or internet-computer allowing users to interact with a local or global network using standard connections and protocols, etc. The processing system may also include a display device 1042 preferably connected or part of the system 120 to display images of a graphical environment, such as a game environment, operating system application, simulation, etc. The display device 1042 may be any of a variety of types of devices, such as LCD displays, LED displays, CRTs, liquid ferrum displays (“LFD”) (e.g., U.S. patent application Ser. No. ______ [T2203-00014] the entirety of which is incorporated herein by reference), flat panel screens, display goggles, etc. FIG. 11 is a depiction of one embodiment of the present subject matter. With reference to FIG. 11, a method 1100 is illustrated for providing haptic feedback to a subject. At step 1110, signals may be provided to an exemplary electronic interactive device, the device including an array of micro-step motors for contacting a skin surface of the subject. These signals may be provided wirelessly or via a wire or cable. In one embodiment, each of the micro-step motors in the array may include two clutching actuators separated by a lateral actuator, each actuator adaptable to operate independently of the other actuators, and a shaft having a motion defined by movement of at least one of the lateral or clutching actuators. Further, an exemplary device may be, but is not limited to, a garment, touchpad, touchscreen, display, keyboard, button, glove, suit, tool, shirt, hat, goggles, spectacles, shoes, pants, socks, undergarments, clothing accessories, necklaces, bracelets, jewelry, and combinations thereof. At step 1120, the provided signals may be converted to provide an input to the array of micro-step motors. In one embodiment, the input signal may be a function of a stepping voltage. At step 1130, haptic feedback may be provided to the skin surface of the subject in response to the input. In another embodiment, the method may include the steps of providing one or more transponders on the device, and tracking movement of the device as a function of signals provided or reflected by the one or more transponders.

It will be appreciated that, for clarity purposes, the above description has described embodiments of the present subject matter with reference to different functional units and processors. However, it will be apparent that any suitable distribution of functionality between different functional units or processors may be used without detracting from the present subject matter. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

It should be noted that, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate. As shown by the various configurations and embodiments illustrated in FIGS. 1-11, a system, device and method for providing haptic technology have been described.

While preferred embodiments of the present subject matter have been described, it is to be understood that the embodiments described are illustrative only and that the spirit and scope of the present subject matter is to be defined solely by the appended claims when accorded a full range of equivalence, many variations and modifications naturally occurring to those of skill in the art from a perusal hereof.

I claim:

1. An electronic interactive device comprising:
a first surface;
an array of micro-step motors, each motor including:
two clutching actuators separated by a lateral actuator, each actuator adaptable to operate independently of the other actuators, and
a shaft having a motion defined by movement of at least one of said lateral or clutching actuators, an end of said shaft being in contact with said first surface; and
circuitry for receiving signals that provide an input to said array of motors configured to provide haptic feedback in response to said input.

2. The device of claim 1 wherein the first surface comprises a material selected from the group consisting of latex, cloth, neoprene, silicone, polyester, flexible polyvinylchloride, nitrile, ethylene vinyl acetate, ethylene propylene diene monomer rubber, viton, polyether, foam, rubber, fluorosilicone, polycarbonate, cork, nomex, kapton, plastic, elastomers, reversible material, and combinations thereof.

3. The device of claim 1 wherein the lateral and clutching actuators are piezoelectric actuators.

4. The device of claim 1 wherein the device is selected from the group consisting of a garment, touchpad, touchscreen, display, keyboard, tool, button, glove, suit, shirt, hat, goggles, spectacles, shoes, pants, socks, undergarments, clothing accessories, necklaces, bracelets, jewelry, and combinations thereof.

5. The device of claim 1 further comprising one or more transponders adaptable to interact with an incident signal thereon to produce a second signal, wherein the second signal is used to track movement of said transponders.

6. The device of claim 1 wherein the circuitry further comprises a flexible printed circuit board.

7. The device of claim 1 wherein said movement is a function of voltage.

8. A method of providing haptic feedback to a subject comprising the steps of:
providing signals to an electronic interactive device, the device including an array of micro-step motors for contacting a skin surface of the subject;
converting the signals to provide input signals to the array of micro-step motors; and
providing haptic feedback to the skin surface of the subject in response to the input signals.

9. The method of claim 8 wherein each of the micro-step motors in the array further comprise:
two clutching actuators separated by a lateral actuator, each actuator adaptable to operate independently of the other actuators; and
a shaft having a motion defined by movement of at least one of the lateral or clutching actuators.

10. The method of claim 8 wherein the device is selected from the group consisting of a garment, touchpad, touchscreen, tool, display, keyboard, button, glove, suit, shirt, hat, goggles, spectacles, shoes, pants, socks, undergarments, clothing accessories, necklaces, bracelets, jewelry, and combinations thereof.

11. The method of claim 8 wherein the signal are provided to the device wirelessly or via a wire or cable.

12. The method of claim 8 further comprising the steps of:
providing one or more transponders on the device; and
tracking movement of the device as a function of signals provided or reflected by the one or more transponders.

13. The method of claim 8 wherein at least one of said input signals is a stepping voltage signal.

14. An apparatus for delivering haptic stimuli to a skin surface of a user comprising:
an array of micro-step motors for contacting said skin surface; and
a printed circuit board connected to said array for independently providing electrical signals to each of said motors in a predetermined sequence.

15. The apparatus of claim 14 wherein each of the motors further comprises:
two clutching actuators separated by a lateral actuator, each actuator adaptable to operate independently of the other actuators; and
a shaft having a motion defined by movement of at least one of said lateral or clutching actuators, an end of said shaft being in contact with said skin surface.

16. The apparatus of claim 15 wherein the lateral and clutching actuators are piezoelectric actuators.

17. The apparatus of claim 14 wherein the printed circuit board is flexible.

18. The apparatus of claim 14 further comprising a layer of material intermediate said array and skin surface.

19. The apparatus of claim 18 wherein the material comprises at least one of latex, cloth, neoprene, silicone, polyester, flexible polyvinylchloride, nitrile, ethylene vinyl acetate, ethylene propylene diene monomer rubber, viton, polyether, foam, rubber, fluorosilicone, polycarbonate, cork, nomex, kapton, plastic, elastomers, reversible material, and combinations thereof.

20. The apparatus of claim 14 wherein the device is selected from the group consisting of a garment, touchpad, touchscreen, tool, display, keyboard, button, glove, suit, shirt, hat, goggles, spectacles, shoes, pants, socks, undergarments, clothing accessories, necklaces, bracelets, jewelry, and combinations thereof.

21. The apparatus of claim 14 further comprising one or more transponders adaptable to interact with an incident signal thereon to produce a second signal, wherein the second signal is used to track movement of said transponders.
